(19) United States
(12) Patent Application Publication
(10) Pub. No.: US 2006/0139475 A1
(43) Pub. Date: Jun. 29, 2006

(54) Multiple field of view camera arrays

(76) Inventors: John W. Esch, Burnsville, MN (US); Rick C. Stevens, Apple Valley, MN (US); Kevin J. Thorson, Eagan, MN (US); James A. Howe, Burnsville, MN (US); Stephen M. Sohn, Shoreview, MN (US); Timothy R. Zajic, Boxford, MA (US)

Correspondence Address: BROOKS & CAMERON, PLLC, 1221 NICOLLET MALL #500, MINNEAPOLIS, MN, 55403, US

(21) Appl. No.: 11/022,370

(22) Filed: Dec. 23, 2004

(51) Int. Cl. H04N 5/225

(52) U.S. Cl. 348/340

(57) ABSTRACT

Systems and apparatuses are provided that include a number of cameras. One embodiment includes a surveillance camera. The embodiment includes a camera having a lens with a first field of view. The camera can be mounted to an imaging circuit board having an imaging circuit provided thereon for converting image data from the lens into a digital field of view.

### FIELD OF THE INVENTION

The present invention generally relates to cameras and systems using cameras. And, in particular, the present invention relates to apparatuses and systems using a number of cameras to provide multiple fields of view.

### BACKGROUND

Cameras are used for a wide variety of functions and in many different situations. For example, cameras are used to monitor activity in spaces within buildings, such as department stores, malls, and businesses. In these areas, although the cameras are generally protected from exposure to natural elements (such as wind, rain, soil, etc), they may be placed in areas that are not easily accessible and/or may not be regularly maintained for a number of reasons. In such instances, movable parts can wear out or malfunction, which can reduce the effectiveness of the camera or render it inoperable.

Additionally, insects, such as spiders and the like, can obstruct the movement of camera parts. For example, spider webs, the spiders themselves, and/or their victims can become caught in the path of various moving parts of a camera which can also reduce the effectiveness of the camera or render it inoperable.

Cameras can also be used in unprotected environments, such as in the outdoors where the camera can be exposed to various natural elements, insects, and the like. In some instances, the cameras can also be positioned in areas that are not easily accessible and/or where they are not maintained sufficiently. Additionally, replacement parts may not be readily accessible and, therefore, the camera may not be operable for a period of time until replacement parts can be made available.

For example, cameras are often used in aircraft for aerial surveillance of targets on the ground, at sea, etc. In some instances, such as on manned aircraft, although the aircraft has occupants that can perform maintenance on the camera, the parts may not be available while in flight, or may not be available at the aircrafts base of operations. In such situations, the camera may sit idle until the replacement parts arrive.

Cameras are also used on unmanned aircraft. In these situations, the aircraft is inaccessible during flight and if a camera becomes inoperable or its effectiveness reduced, it cannot be fixed until the aircraft returns from its mission. The reduced effectiveness of the camera or its inoperability can also influence the potential for the successful return of the aircraft, since the camera may be used by a remotely located controller to navigate the aircraft to and from a surveillance target.

Further, in such situations, the area available for movement of a camera in order to pan the camera to a different focal point can be restricted due to the small amount of space typically available in unmanned aircraft.

In such instances, digital cameras have been used. Some digital cameras have a large enough resolution to provide a functionality similar to a zoom lens. To accomplish this functionality, a digital camera having a high resolution and a wide field of view can be used. In such cameras, in order to view the entire field of view, some image information is discarded to provide a generally zoomed out resolution. For example, in some devices, every third column of information is discarded.

If a “zoomed in” view of an area is desired, only a portion of the entire field of view is shown in the display, but it is shown with less or none of the image information discarded. For example, in some devices, the full field of view can be segmented into nine display's worth of information at full pixel resolution (3×3).

In these devices, the ratio of full field of view to small field of view is 3 to 1. In this way, the fine detail of the image can be shown. Additionally, this allows the digital camera to pan over an area that is the size of the “zoomed out” image, for example. In such cameras, the change of field between large and small can be accomplished through the use of computer executable instructions which can select and format the image data from the camera.

Since the digital camera can obtain both a wide field of view and a detailed small field of view and, if a ratio such as 3 to 1 is acceptable, then the camera does not have to utilize moving parts for this pan and zoom functionality. However, if other fields of view or resolutions are desired, these types of digital cameras have to make use of lenses and movable parts to accomplish the other fields of view and resolutions.

Additionally, in some situations, such as in unmanned aircraft, weight and size are also important characteristics regarding camera design. In this regard, digital cameras are typically lighter and small than cameras with movable components. Further, when using a single movable lens, compromises may have to be made on the amount of zoom available based upon the limitations of the lens selected.

### SUMMARY

Embodiments of the present invention provide apparatuses and systems having a number of cameras. For example, camera embodiments can include digital surveillance cameras having a first field of view and a second field of view that is wider than the first field of view. The camera can generate image data and an imaging circuit can be used for converting the image data into a digital field of view.

In such embodiments, the camera can be mounted to an imaging circuit board. The imaging circuit can be formed on the imaging circuit board. The imaging circuit can be used to select a portion of the image data for conversion based upon a selected area within a field of view. The imaging circuit can include circuitry and/or computer executable instructions for converting the image data. The camera can also include a signal processing board for performing a conversion of the image data into a signal to be transmitted. Such camera embodiments can also include circuitry and/or computer executable instruction to provide a digital panning capability.

Embodiments of the present invention provide camera arrays including various numbers of cameras. As used herein, the term camera array includes one or more cameras. For example, in various embodiments, the camera array can include a first and a second camera, among others.

In such embodiments, the first camera can have a first field of view, while the second camera has a second field of view that is different than the first field of view. In this way, the multiple cameras can compliment each other with respect to the field of view and zoom capabilities available to the overall functionality of the system. For example, the camera fields of view can be combined to provide a larger composite field of view and/or can be compliment each other by providing varying fields of view and zoom ratios for an area around a focal point.

In some embodiments, the multiple cameras can be fixed with respect to each other. In this way, the structures mounting the cameras to a backing plate or circuit board do not have articulating parts that could become damaged or their movement restricted. In such embodiments, the cameras can be directed to the same focal point or to different focal points as described above.

If digital cameras are used, the cameras themselves do not have to utilize movable parts. This can be beneficial, for example, in circumstances where the camera may not receive regular maintenance and/or in environments that expose the camera to natural elements, such as, water, soil, salt, and the like, among others.

In some embodiments, the digital cameras can include digital magnification and/or demagnification capabilities. In this way, a camera can be used for multiple fields of view, multiple pan factors, and multiple zoom factors. When combined with other cameras, such combinations can provide the user with more field of view, pan, and/or zoom options.

The cameras can also be directed at the same focal point. When multiple cameras are directed to the same focal point, these embodiments provide many field of view choices for the area centered around the focal point. In some embodiments, the camera array can be moved to change the area to be viewed that is aligned with the focal point of the multiple cameras.

The cameras used in the embodiments of the present invention can have any field of view that can be provided by a camera lens. For example, some possible fields of view can include 3.3 degrees, 10 degrees, 30 degrees, and 90 degrees. These exemplary fields of view can also serve as an example of the fields of view available from a four camera array.

Such an array can, for example, provide a continuous ability to zoom from 90 degrees down to approximately one degree. This can be accomplished by manual switching from one camera to another in a camera array, for example. This can also be accomplished through use of computer executable instructions that can switch from one camera to the next, when a low field of view or high field of view threshold is reached.

In some embodiments, an imaging component can be used that includes mega-pixel imaging control and interfacing circuitry. Since a digital picture is a digital interpretation of an actual scene viewed by the camera, the mega-pixel imaging control is used with digital cameras to aid in the construction of the pixels in order to represent the area of a scene that is being replicated in the image data. Interfacing circuitry can be used to connect the various control and imaging circuitry together to allow for intercommunication between the various control and imaging components.

Examples of imaging controls that can be provided in various embodiments include, but are not limited to, shutter time, shutter delay, color gain (e.g., can be in one or more of red, green, blue, monochrome, etc), black level, window start position, window size, and row and column size, white balance, color balance, window management, and algorithms that determine the value of these camera controls for various situations, to name a few. These controls can be accomplished through circuitry and/or computer executable instructions associated with the imaging circuitry. Additionally, circuitry and/or computer executable instructions can be executed on a signal processor, such as a digital signal processor, or other processing component, to implement some of the above functions.

In various apparatus embodiments, the apparatus can include a camera array connected to a mounting structure. For example, and the camera and/or camera array can be mounted to a fixed mounting structure or a movable mount, for moving the camera array. As discussed above, the camera array can be mounted such that the entire array is moved together. In this way, the varied fields of view and zoom ratios of the cameras can be used in combination to provide a number of pan and zoom options for viewing the area in which the camera array is directed.

The movable mount can be designed to move the camera array in any manner. For example, the movable mount can be designed to rotate in one or more dimensions. In this regard, the movable mount can be designed to rotate 180 degrees, for example, around a center point in one or more dimensions. This can be beneficial when the cameras are to be used to view through a hole in a surface, such as the bottom of an aircraft or a ceiling of a room. However, the invention is not limited to such movement and embodiments can include more, less, or different types of movement.

Additionally, the use of a movable mount can also be used in combination with the digital panning features of a digital camera to allow a user to digitally pan to the edge of a digital field of view and then use a motorized movable mount to pan the camera array beyond the current digitally available field of view. This can be accomplished with a mount controller, such as a processor and computer executable instructions to switch between digital panning and physical panning through use of the movable mount.

In some embodiments, an apparatus can include a camera array having multiple cameras that generate image data. The image data can be handled in various manners. For example, the image data can be stored in memory, displayed on a display, communicated to another apparatus or system, passed to an application program, and/or printed on print media, etc.

Memory can be located proximate to one or more of the cameras (e.g., within a surveillance vehicle) or at a remote location, such as within a remote computing device at a base of operations at which a surveillance mission originated, is controlled, or has ended. In such instances, the image data can be stored in memory, as discussed above. For example, an apparatus provided in a surveillance vehicle can store the image data in memory when in the field. The information can then be sent to a remote device once the vehicle has exited a hostile area or remote area, or has returned from the mission.

The transmission of the image data can be accomplished via wired or wireless communication techniques. In embodiments where image data is transmitted or stored, the apparatus can also include an imaging circuit for converting the image data for storage in memory, and/or into a signal to be transmitted.

In some embodiments, the apparatus can also include a switching circuit for switching between the image data from the one camera to the image data from another camera for conversion into the signal to be transmitted. Additionally, an imaging circuit can be used to select a portion of the image data for conversion based upon a selected field of view. In some embodiments, each camera can have its own imaging circuit.

A remote user, in various embodiments, can select a camera and a field of view and/or zoom ratio (e.g., selected area within a field of view) for the image data that is to be sent to the user. The apparatus can then configure the camera array settings to provide the selected image data to the user.

In some embodiments, the apparatus can use a digital signal processing (DSP) board for performing the conversion of the data to be stored, displayed, transmitted, and/or printed, etc. The DSP board can be a part of, or connected to, the one or more imaging circuits of the apparatus.

The embodiments of the present invention also include a number of multiple camera system embodiments. In some embodiments, the system includes a camera array having multiple cameras. The cameras generate image data that can be provided to a computing device, such as, or including, a DSP board, having computer executable instructions for receiving and/or processing the image data. In some embodiments, the computing device can be located in a remote location with respect to the cameras. The computing device can also be located proximate to one or more of the cameras, in some embodiments.

The computing device can include a display for displaying the received image data and/or a printer for printing the image data. For example, the image data can be sent directly to a printer. The printer can receive the image data and print the received image data on a print medium.

The image data can also be sent to a computing device such as a desktop or laptop computer with a display and the information can be displayed thereon. In some embodiments, a display can be used to aid in navigating the device by allowing a remote controller (e.g., user) to have a view from an unmanned vehicle, such as a marine craft, land craft, or aircraft.

Additionally, the image data can be provided to a computing system having a number of computing devices, such as a desktop computer and number of peripherals connected to the desktop, such as printers, etc. The computing system can also be a network including any number of computing devices networked together.

In various embodiments, the computing device can include computer executable instructions to send image data requests to the camera array. In this way, the computing device can potentially receive a selected type of image data based upon a request originated at the computing device. For example, the image data requests can include a camera to be selected to obtain a view and a selected field of view, among other such parameters that can be used to determine the type of image data to be provided.

In many such embodiments, the computing device can include a user interface to allow a user to make image data requests. However, in some embodiments the computing device can include computer executable instructions that can be used to automate the selection of a number of different views from the camera array without active user input. For example, a user can make the selections ahead of time, such as through a user interface, and/or computer executable instructions in the form of a program can be designed that can be used to select the same image data when executed. In some embodiments, the program can be a script or other set of instructions that can be directly executed or interpreted. Such programs may be combined with a file or database can be used to make selections.

Various embodiments can also include a variety of mechanisms for transferring image data and camera control signals. For example, various embodiments can include an image data transceiver. A transceiver can send and receive data. A transmitter and receiver combination can also be used in various embodiments to provide the sending and receiving functions.

The image data transceiver can include computer executable instructions for receiving instructions from a remote device and for selecting a field of view based upon the received instructions. The image data transceiver can also include computer executable instructions for receiving instructions from a remote device and for selecting one of the cameras based upon the received instructions.

Embodiments can also include one or more antennas and transmission formats for sending and/or receiving information. One example of a suitable format is a National Television Systems Committee (NTSC) standard for transmitting image data to a remote device. The Federal Communications Commission established the NTSC standard of defining lines of resolution per second for broadcasts in the United States. The NTSC standard combines blue, red, and green signals with an FM frequency for audio. However, the invention is not limited to transmission based upon the NTSC standard or to antennas for communicating NTSC and/or other types of formatted signals.

Various embodiments can also include a mount controller. In various embodiments, the mount controller can include circuitry to receive a signal from a remote device. The mount controller can also include circuitry to move the movable mount based upon the received signal. In some embodiments, the mount controller can include computer executable instructions to receive signals from a remote device and to move the movable mount based upon the received signal.

In such embodiments, the mount controller can include a radio frequency (RF) or other type of antenna for receiving control signals from a remote device, such as from a remote computing device. In such instances, the remote device is equipped with a transmitter or transceiver to communicate with the mount controller.

Those of ordinary skill in the art will appreciate from reading the present disclosure that the various functions provided within the multiple camera embodiments (e.g., movement of the mount, camera selection, field of view selection, pan selection, zoom selection, and the like) can be provided by circuitry, computer executable instructions, antennas, wires, fiber optics, or a combination of these.

### BRIEF DESCRIPTION OF THE DRAWINGS

FIG. 1A is an illustration of an embodiment of a multiple camera apparatus.

FIG. 1B is an illustration of another embodiment of a multiple camera apparatus.

FIG. 1C is an illustration of varying fields of view of the multiple camera apparatus embodiment of FIG. 1B.

FIG. 2 is an illustration of an embodiment of a camera assembly.

FIG. 3A is an illustration of an embodiment of a multiple camera apparatus.

FIG. 3B is another illustration of an embodiment of a multiple camera apparatus.

FIG. 4 is an illustration of another embodiment of a multiple camera apparatus.

FIG. 5A is an illustration of an embodiment of a multiple camera system similar to that shown in FIG. 3A.

FIG. 5B is an illustration of an embodiment of a multiple camera system similar to that shown in FIG. 3B.

FIG. 6A is an exemplary table of information illustrating the horizontal fields of view of an embodiment of the invention.

FIG. 6B is an exemplary table of information illustrating the zoom ratios of an embodiment of the invention.

### DETAILED DESCRIPTION

Embodiments of the present invention include systems and apparatuses having multiple camera arrays. Embodiments of the present invention will now be described in relation to the accompanying drawings, which will at least assist in illustrating the various features of the various embodiments.

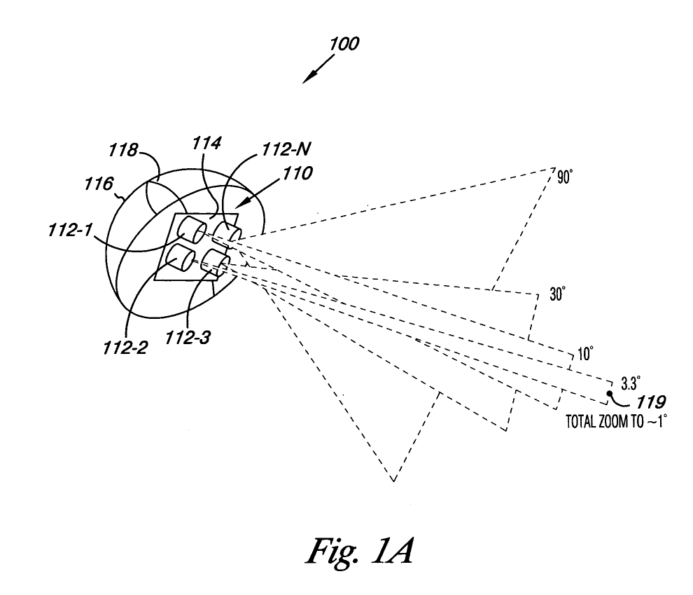

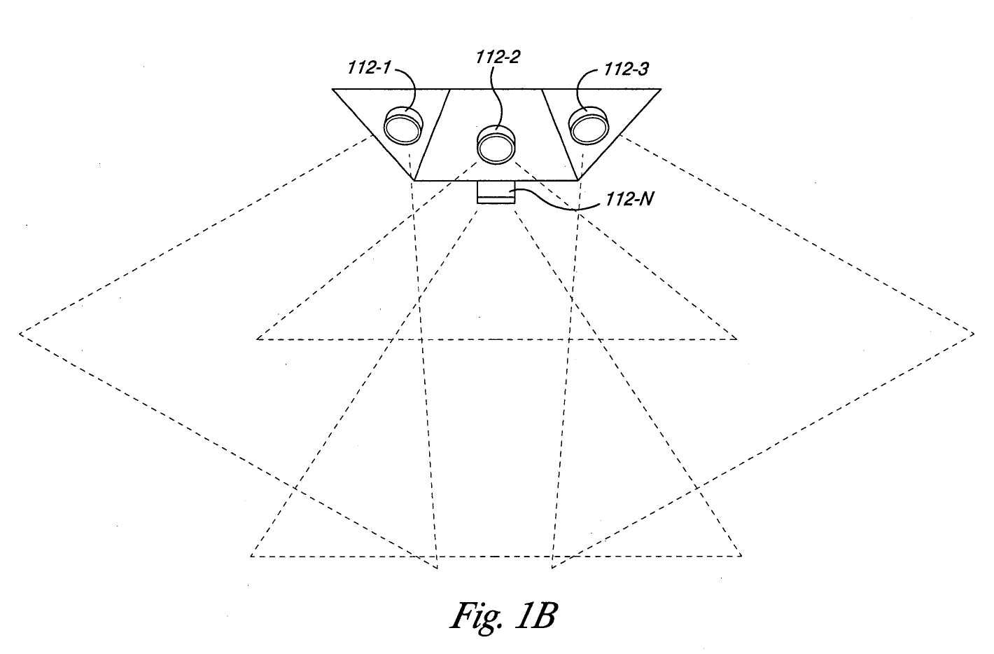

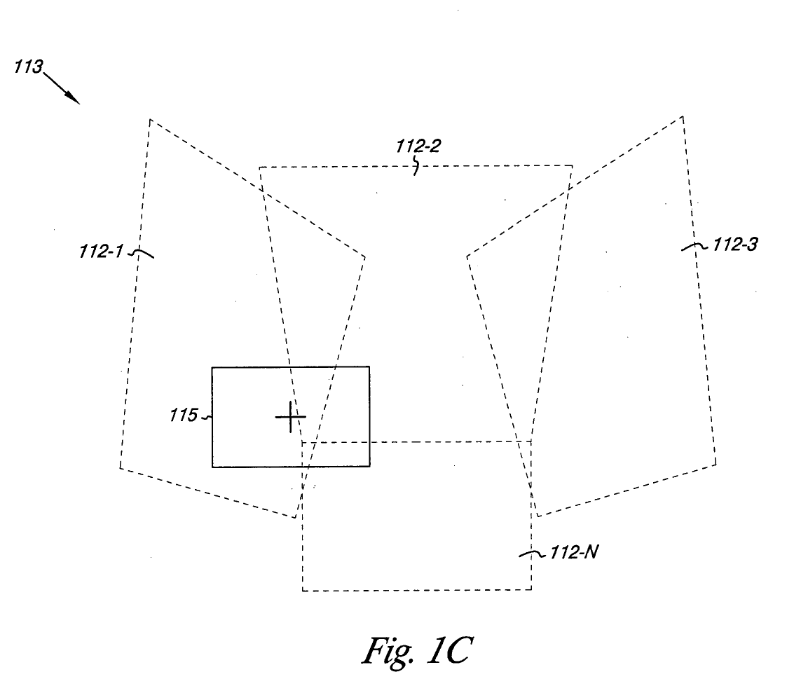

FIG. 1A is an illustration of an embodiment of a multiple camera apparatus. In the embodiment of FIG. 1A, a multiple camera apparatus 100 is illustrated having electronic zoom and panning capabilities. The apparatus 100 includes a mounting plate 114 and a camera array 110 which includes cameras 112-1, 112-2, 112-3, and 112-N.

The use of the symbols “M”, “N”, “Q”, “R”, “S”, “T”, and “U” herein are used to represent the numbers of particular components, but should not be construed to limit the number of any other items described herein. And, the numbers represented by each symbol can each be different. Additionally, the terms horizontal and vertical have been used to illustrate relative orientation with respect to each other and should not be viewed to limit the elements of the invention to such directions as they are described herein.

The mounting plate 114 can be used, for example, to attach the camera array to a movable mount, as described in more detail below. The mounting plate 114 can be made of any material and can include a circuit board, such as an imaging circuit board or a DSP circuit board. Additionally, in some embodiments, the mounting plate 114 can be a circuit board, such as an imaging circuit board or a DSP circuit board.

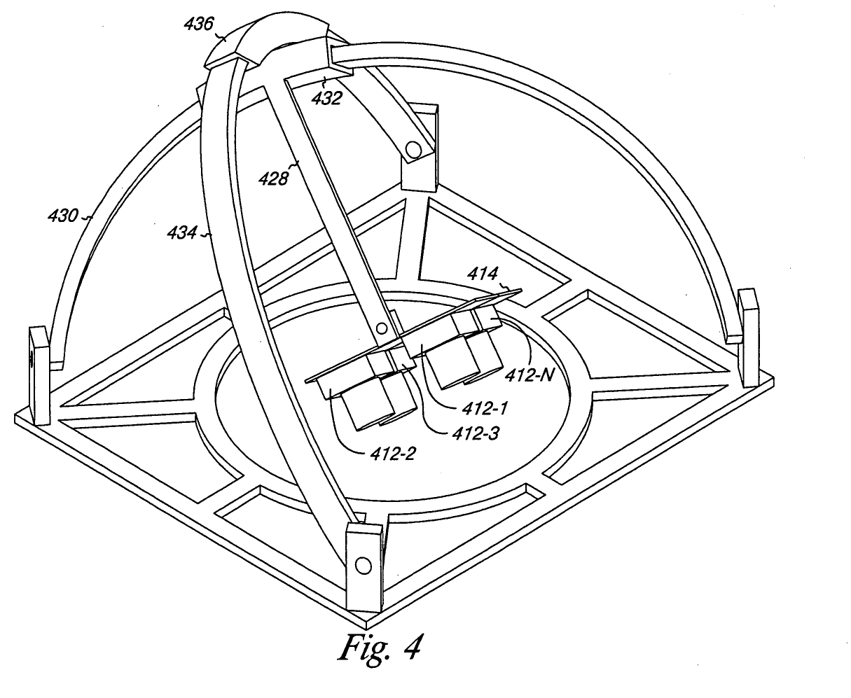

Elements 116 and 118 illustrate an example of a range of motion for the camera array of FIG. 1A. The element 116 illustrates a 180 degree range of motion in one dimension. The element 118 illustrates a 180 degree range of motion in a second dimension. The combination of the two one-dimensional ranges of motion provides a total three dimensional range of motion for this embodiment that is hemispherical in shape as is illustrated in FIG. 1A. The motion of camera array embodiments will be further described with respect to FIG. 4 discussed below. Those skilled in the art will appreciate that the range of motion and type of motion shown in FIG. 1A is one of many types of motion that can be used and that the embodiments of the present invention are not limited to the range of motion or to type of movement shown.

In the embodiment shown in FIG. 1A, the multiple cameras 112-1 to 112-N each have a different field of view and zoom ratio. Although their field of view and zoom ratios may overlap as shown in FIG. 1A, the different characteristics of the cameras and their orientations relative to each other can compliment each other to provide more zoom, pan, and field of view options.

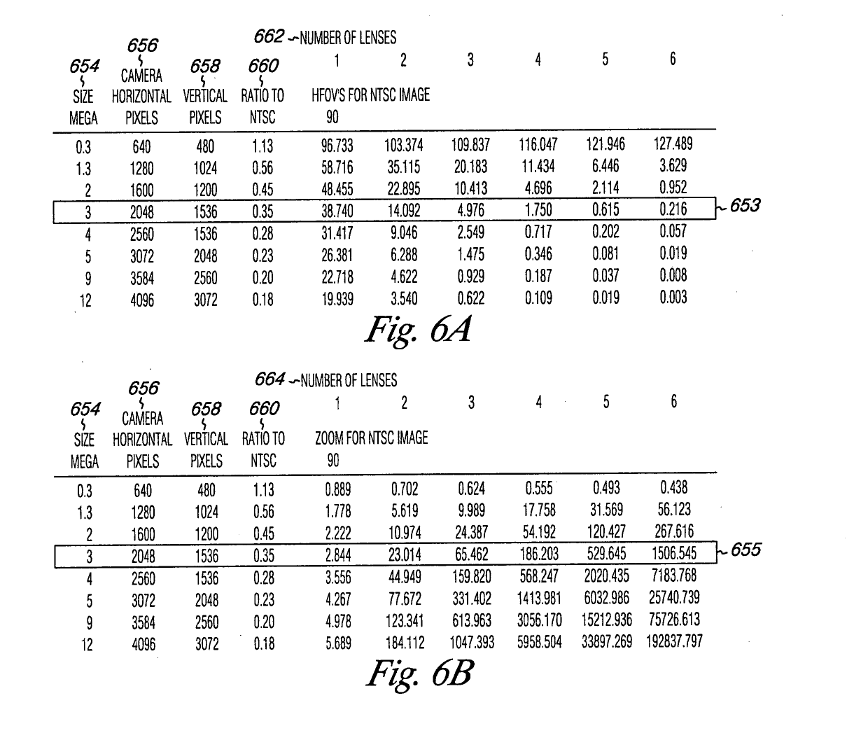

In the embodiment shown in FIG. 1A, the narrowest field of view (e.g., 3.3 degrees), also called the lowest field of view, and highest zoom ratio are provided by camera 112-2. As shown in FIG. 1A, in this embodiment, the camera array 110 can zoom to display a field of view of approximately 1 degree. The next wider field of view in this embodiment is provided by camera 112-1 (e.g., 10 degrees). The second widest field of view is provided by camera 112-3 (e.g., 30 degrees). The widest field of view, also called the highest field of view, is provided by camera 112-N (e.g., 90 degrees). As depicted in FIG. 1A, in this embodiment, camera 112-N also has the lowest zoom ratio. For more information about fields of view and zoom ratios, examples of zoom and field of view calculations for arrays having up to six cameras are shown and discussed with regard to FIGS. 6A and 6B.

Also, FIG. 1A illustrates an embodiment in which the cameras are all generally direct to the same focal point 119. In this way, the multiple cameras can provide a variety of field of view and zoom ratio options when viewing the area around the focal point.

FIG. 1B is an illustration of another embodiment of a multiple camera apparatus. In this embodiment, the cameras 112-1, 112-2, 112-3, and 112-N are each directed at a different focal point and, accordingly, each have a different field of view. The embodiment illustrated in FIG. 1B also has the cameras positioned such that a portion of each of the fields of view (indicated by the dashed lines), overlap each other slightly.

Each of the fields of view of the cameras has an edge. The fields of view can be of any suitable shape. For example, a field of view can be, be circular or oval shaped, in which case, the field of view has one edge. The field of view can be polygonal in shape, or an irregular shape, for example, in which case, the field of view has three or more edges. In many digital imaging cameras, the imaging sensors are rectangular and, therefore, the field of view is rectangular in shape and has four edges. In various embodiments, the cameras can be positioned such that portions of the edges of at least two fields of view can abut or overlap each other. In this way, a composite image can be created based upon the overlapping or abutting relationship between the fields of view, as will be discussed in more detail with respect to FIG. 1C.

FIG. 1C is an illustration of varying fields of view of the multiple camera apparatus embodiment of FIG. 1B. In FIG. 1C, the fields of view of cameras 112-, 112-2, 112-3, and 112-N are illustrated. In this embodiment, the fields of view all overlap at least one other field of view. Additionally, the fields of view of camera 112-2 and 112-N abut each other along the bottom edge of the field of view of camera 112-2 and the top edge of the field of view of camera 112-N.

In some such embodiments, any combination of fields of view can be combined. For example, the fields of view of 112-2 and 112-N can be combined to provide a larger composite field of view 113. In the embodiment shown in FIG. 1C, the fields of view of cameras 112-1 to 112-N have been combined to provide a larger composite field of view 113.

In embodiments such as that shown discussed with respect to FIGS. 1B and 1C, the camera array can be associated with imaging circuitry and/or computer executable instructions that can create a composite field of view 113, and/or image data set. This can be accomplished, for example, by combining the non-overlapping data of some fields of view with a set of overlapping data from one of the one or more overlapping fields of view for each overlapping portion.

For example, in order to show a composite image, the data sets from camera 112-2 and 112-N can be used (since they are abutting, there is no duplicate data to ignore or discard). In addition, non-overlapping image data from cameras 112-1 and 112-3 can be added to the image data from cameras 112-2 and 112-N to create a composite image data set for the field of view encompassed within the fields of view of cameras 112-1 to 112-N without any duplicate data therein. In other embodiments, all of the image information for the selected fields of view can be combined.

In some embodiments, duplicate information can then be compared, combined, ignored, and/or discarded. For example, overlapping image data can be compared to determine which image data to use in the composite image, such as through use of an algorithm provided within a set of computer executable instructions. Computer executable instructions can also select a set or average the sets to provide lighting and/or color balance for the composite image, among other such functions.

In some embodiments, the composite field of view can be larger than can be printed or displayed. In such embodiments, a portion of the combined image data can be viewed. For example, as shown in FIG. 1C, the display area is shown at 115. The size of the area is smaller than the viewable area of the composite field of view 113. In such embodiments, different portions of the viewable area can be selected for viewing. In this way, the viewer can digitally pan in a number of directions to view different portions of the viewable area or zoom to digitally change the size of the portion of the composite field of view 113 shown in the display area 115. In addition, in some embodiments, when an edge of the viewable area is reached by movement of the display area, the cameras can be panned to direct their focal points such that the area desired for viewing is provided within the composite field of view 113.

In these embodiments, imaging circuitry and/or computer executable instructions can be used to collect, combine, discard, and/or ignore the field of view image data for forming the composite image and/or composite image data set. Imaging circuitry and/or computer executable instructions can also be used to select the portion of the composite image to be viewed, allow for the user selection of the portion of the image to be viewed, the selection of the fields of view to be used in forming the composite image, and/or the method of forming the composite image, among other uses.

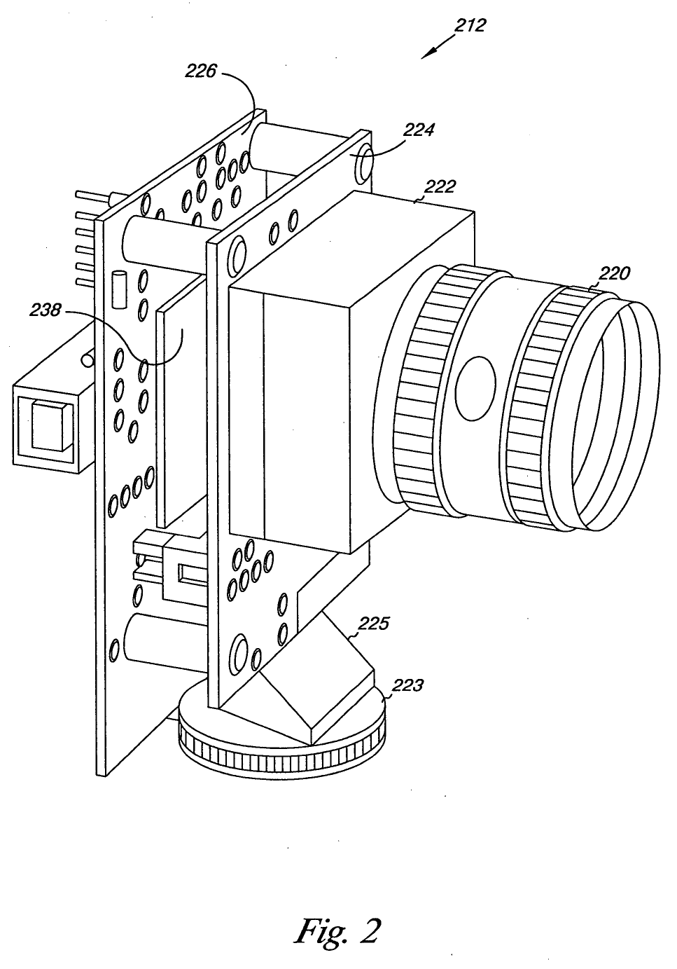

FIG. 2 is an illustration of an embodiment of a camera assembly. In this embodiment, the camera 212 includes a lens 220, a lens mount 222, an imaging circuit board 224, and a DSP circuit board 226. Embodiments of the present invention can include adjustable or fixed aperture lenses. The lens mount 222 is used to mount the lens 220 to the imaging circuit board 224. In this way, the embodiment can have a small form factor, since the lens is mounted to the surface of the imaging circuit board 224.

In the embodiment shown in FIG. 2, the imaging circuit board 224 is mounted to the DSP circuit board 226. In the embodiment shown, the DSP circuit board 226 includes a processor 238. The functions of the processors of such apparatuses and systems are discussed in more detail herein. In the example shown in FIG. 2, the imaging circuit board 224 is spaced from the surface of the DSP circuit board 226 in order to allow airflow to aid in keeping the processor 238 cool, among other reasons.

Additionally, the DSP circuit board 226 is illustrated in the embodiment of FIG. 2 as being mounted behind the imaging circuit board 224. In this way, the form factor for this embodiment of the camera can be reduced. However, those of ordinary skill in the art will appreciate that the embodiments of the present invention are not limited to such arrangement of components and that the DSP and imaging circuitry can be provided on more or less circuit boards. Embodiments having multiple circuit boards can be connected with flex circuitry, cables, and/or fibers, and the like.

The embodiment shown in FIG. 2 also includes a mounting structure which includes a mounting plate 225 for attachment to the camera assembly and a mounting portion 223 for attachment to a movable mount. In the embodiment shown in FIG. 2, the mounting portion 223 is circular and is typically engaged along its circular edge. The circular edge includes a number of detents in which a portion of a movable mount can engage to hold the camera assembly in position. In various embodiments, the movement of the camera assembly can be achieved by manual adjustment of the movable mount or through the use of a motorized movable mount.

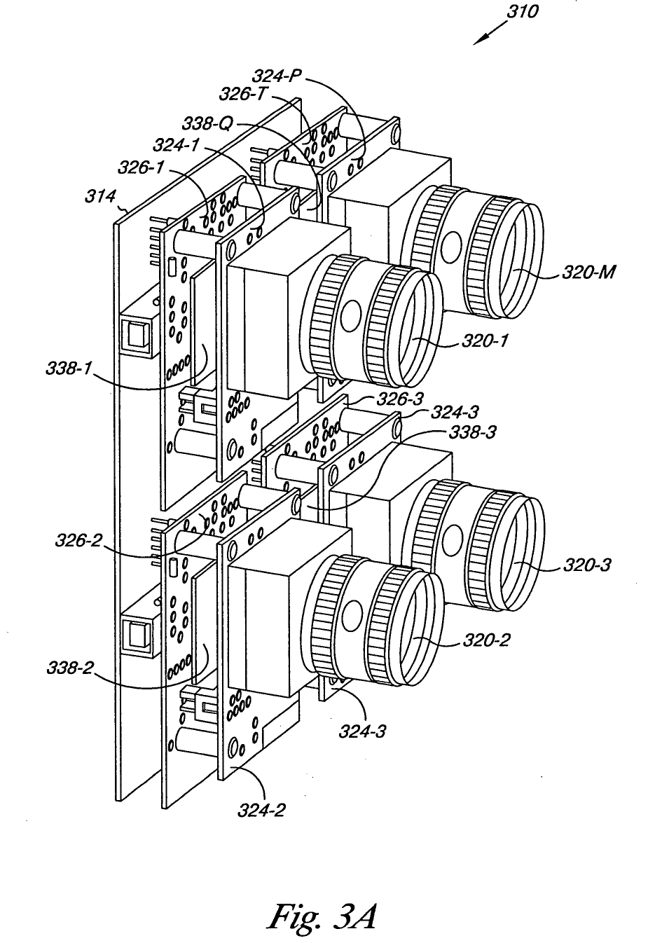

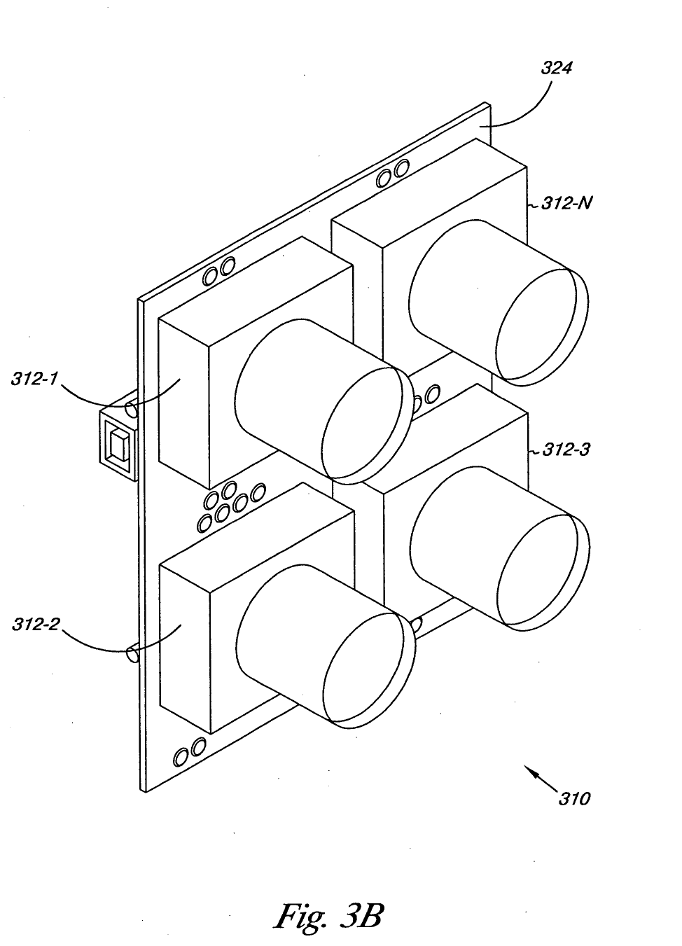

FIG. 3A is an illustration of an embodiment of a multiple camera apparatus. In the embodiment shown in FIG. 3A, the multiple camera apparatus includes a camera array 310, an imaging circuit board 324, and a DSP circuit board 326. In the embodiment illustrated, the camera array 310 includes four cameras (i.e., 312-1, 312-2, 312-3, and 312-N).

The cameras can be of any type. For example, the cameras shown in FIG. 3 are similar to the one shown in FIG. 2. In this embodiment, the cameras are mounted to a mounting plate 314. As shown in FIG. 3A, in various embodiments, multiple camera arrays can be created by the combination of multiple camera assemblies, such as camera assembly 212 shown in FIG. 2. In various embodiments, a multiple camera array, such as that shown in FIGS. 3A and 3B can include computer executable instructions to automatically switch from one camera to another. Computer executable instructions can be used to switch based upon the selection of a particular camera or based upon a desired level of zoom or field of view selected. Additionally, in some embodiments, the computer executable instructions can provide switching based upon an active zoom feature, such that when a user instructs the camera array to zoom in or out, the imagery circuitry incrementally increases or decreases the zoom of the field of view. In doing so, the computer executable instructions can be used to switch from one camera to another camera having the next higher of lower zoom range, for example. In various embodiments, the switching between cameras can be transparent to the user, such that they see a continuous or step-wise change in the zoom.

FIG. 3B is another illustration of an embodiment of a multiple camera apparatus. In the embodiment shown in FIG. 3B, the multiple camera apparatus includes a camera array 310, a circuit board 324, including both imaging and DSP circuitry. In the embodiment illustrated, the camera array 310 includes four cameras (i.e., 312-1, 312-2, 312-3, and 312-N).

In contrast to the cameras shown in FIGS. 2 and 3A, which included multiple independent imaging and computing boards, the embodiment shown in FIG. 3B has an integrated imaging and computing circuit board that includes a number of digital cameras that utilize digital magnification and demagnification (i.e., zoom in and out) capabilities. In this embodiment, the circuit board 324 serves all of the cameras in the array. This can be accomplished by having one set of DSP and imaging circuitry on the circuit board 324 that serves all of the cameras or by having multiple sets of imaging and DSP circuitry on one or more circuit boards, such as circuit board 324, or a combination thereof.

FIG. 4 is an illustration of another embodiment of a multiple camera apparatus. In this embodiment, the apparatus includes a movable mount that provides a hemispherical range of movement similar to that discussed with respect to the embodiment of FIG. 1. The embodiment of FIG. 4 includes a number of cameras 412-1 to 412-N, a mounting plate 414, a mounting arm 428, a movement guide 430 and movement path 432 in one dimension, and a movement guide 436 and movement path 434 in a second dimension. The camera array is similar to that shown in FIG. 3B, wherein the cameras 412-1 to 412-N are mounted to one circuit board 414 that includes imagery and DSP circuitry. In this embodiment, the mounting arm 428 is mounted to the circuit board which is acting as a mounting plate 414.

In the embodiment shown in FIG. 4, the movement guides 430 and 436 move along movement paths 432 and 434 respectively to define the hemispherical path in which the multiple camera apparatus can be moved. In this way, the focal point of the camera array can be directed to most, if not all points within an opposite hemisphere (i.e., the other portion of the sphere formed in part by the sphere of movement provided by the movable mount.

A mounting arm 428 can be used, as shown in FIG. 4, to position the camera array with the area of movement of the movable mount. In the embodiment shown in FIG. 4, the camera array is positioned such that the movement of the cameras is reduced, or minimized. In this way, the cameras can record images from generally the same frame of reference for each focal point to which they are directed. This position also allows the movement of the camera to be better predicted. In such embodiments, there is also less movement of the camera array which can reduce the stress (vibration, stock forces, etc.) on the cameras, among other benefits.

As discussed above, the camera array can be mounted to the mounting arm 428 through use of a mounting plate 414. The mounting arm 428 and mounting plate 414 can be made of any materials. Additionally, as stated above, a circuit board, such as an imaging circuit board, a DSP circuit board, or a combined circuit board, among others, can be used to mount the camera array to the mounting arm 428.

Through use of a motorized mount and a digital camera, some embodiments can have a panning functionality that incorporates both the digital panning capability of the camera and the physical panning capabilities of the motorized mount. For example, a user can instruct the imaging circuitry to digitally pan within the digital field of view of the camera array. When the user pans to the edge of the digital field of view, a mount controller, such as a processor, can activate the motor(s) of the movable mount to move the camera array in the panning direction instructed by the user. In some embodiments, this switching between digital and manual panning can be transparent to the user, so that the user does not know that they have switched between digital and physical panning. However, embodiments are not so limited.

Additionally, the panning and selection of image data to be captured or transmitted can be accomplished in coordination with a guidance apparatus, such as a global positioning system (GPS), inertial navigation system (INS), and/or other such device or system, in order to collect information about a particular target for imaging. In such embodiments, imaging circuitry and/or computer executable instructions can be used to track the camera array position with respect to the location of the target and can adjust the camera array accordingly.

Those of ordinary skill in the art will appreciate that the example structure and type of movement shown in FIG. 4 is but one example of the possible types of movement and movement structures that can be utilized with respect to the embodiments of the present invention.

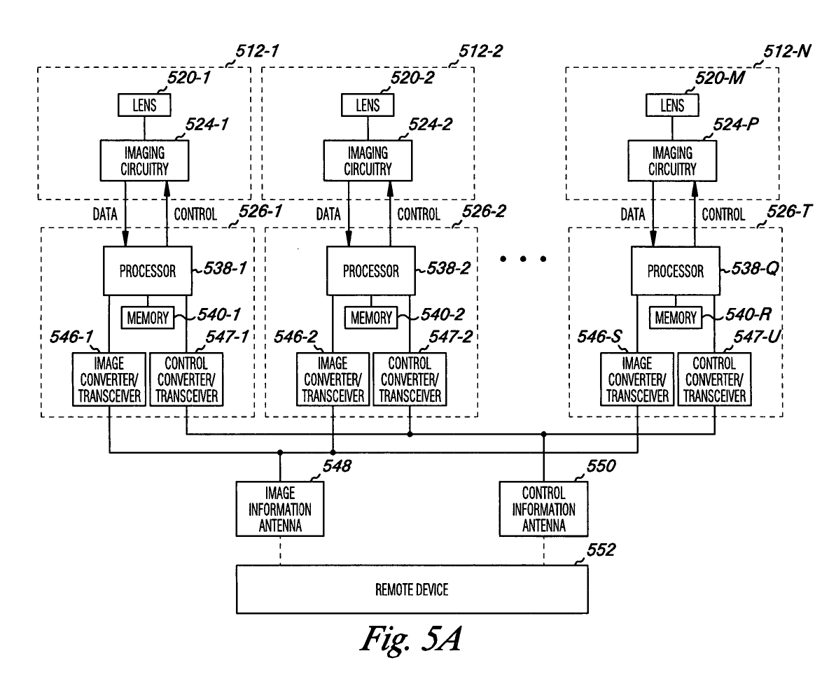

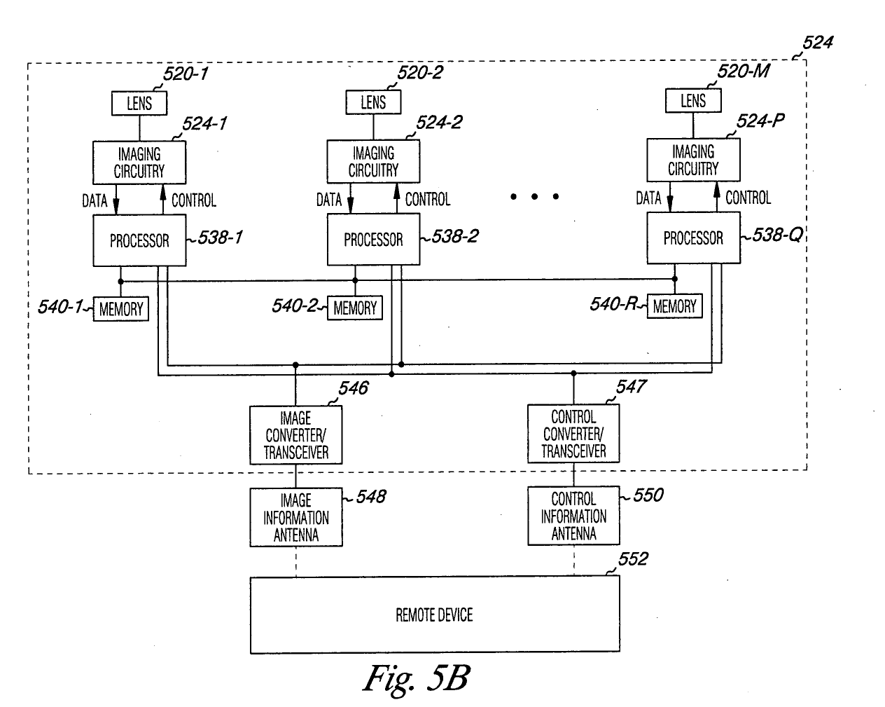

FIG. 5A is an illustration of an embodiment of a multiple camera system similar to that shown in FIG. 3A. The illustrated embodiment includes a number of cameras assemblies 512-1, 512-2, 512-3, and 512-N. In the embodiment shown in FIG. 5A, each camera assembly includes a lens (e.g., 520-1, 520-2, 520-3, to 520-M) and imaging circuitry (e.g., 524-1, 524-2, 524-3, to 524-P).

Image data and control information are passed between the camera assemblies 512-1 to 512-N and a number of circuit boards 526-1, 526-2, 526-3, to 526-T. Each circuit board includes a processor (e.g., 538-1, 538-2, 538-3, to 538-Q), memory (e.g., 540-1, 540-2, 540-3, to 540-R), an image information converter/transceiver (e.g., 546-1, 546-2, 546-3, to 546-S), and a control information converter/transceiver (e.g., 547-1, 547-2, 547-3, to 547-U). These components can be used to select and format image data to be collected, and to process, store, display, transmit, and/or print collected image data. The components can also be used to control the selection of, zoom, pan, and movement of the cameras and camera array.

Memory 540-1, 540-2, 540-3, to 540-R can be used to store image data and computer executable instructions for receiving, manipulating, and sending image data as well as controlling the camera array movement, selecting a camera, a field of view, and/or a zoom ratio, among other functions. Memory can be provided in one or more memory locations and can include various types of memory including, but not limited to RAM, ROM, and Flash memory, among others.

One or more processors, such as processor 538-1, 538-2, 538-3, to 538-Q can be used to execute computer executable instructions for the above functions. The imaging circuitry 524-1, 524-2, 524-3, to 524-P and DSP circuitry on circuit boards 526-1, 526-2, 526-3, to 526-T, as described above, can be used to control the receipt and transfer of image data and can control the movement of the camera array and, in some embodiments, can control selection of cameras, fields of view, and/or zoom ratios. Additionally, these functionalities can be accomplished through use of a combination of circuitry and computer executable instructions.

As discussed above, the information can be directed to other devices or systems for various purposes. This direction of the information can be by wired or wireless connection.

For example, in the embodiment illustrated in FIG. 5A, the image information converter/transceivers 546-1, 546-2, 546-3, to 546-S, and the control information converter/transceivers 547-1, 547-2, 547-3, to 547-U are connected to one or more antennas. For example, in FIG. 5A, the image information converter/transceivers are connected to an image information antenna 548 and the control information converter/transceivers are connected to a control information antenna 550.

The image information antenna 548 can be of any suitable type, such as an NTSC antenna suited for communicating information under the NTSC standard discussed above. The camera control antenna 550 can also be of any suitable type. For example, antennas for communicating wireless RF information are one suitable type.

The embodiment shown in FIG. 5 also includes a remote device 552. As stated above, the remote device can be any type of device for communication of information to or from the image information antenna and/or the camera control antenna. Such devices include computing devices and non-computing devices such as remote RF transmitting devices, and the like.

FIG. 5B is an illustration of an embodiment of a multiple camera system similar to that shown in FIG. 3B. The illustrated embodiment includes a number of camera assemblies provided on a circuit board 524. In the embodiment shown in FIG. 5B, each camera assembly includes a lens (e.g., 520-1, 520-2, to 520-M) and imaging circuitry (e.g., 524-1, 524-2, to 524-P) and is integrated onto the circuit board 524.

Image data and control information are passed between the imaging circuitry 524-1, 524-2, to 524-P and a number of processors 538-1, 538-2, to 538-Q provided on the circuit board 524.

The circuit board 524, shown in FIG. 5B, also includes memory (e.g., 540-1, 540-2, to 540-R) connected to the processor. The memory 540-1, 540-2, to 540-R and processors 538-1, 538-2, to 538-Q function in the same manner as those described with respect to FIG. 5A and, therefore, will not be discussed in detail with respect to FIG. 5B.

The circuit board 524, shown in FIG. 5B, also includes an image information converter/transceiver 546 and a control information converter/transceiver 547. As stated with respect to the embodiment shown in FIG. 5A, the circuit board components described above can be used to select and format image data to be collected, and to process, store, display, transmit, and/or print collected image data. The components can also be used to control the selection of, zoom, pan, and movement of the cameras and camera array.

In the embodiment shown in FIG. 5B, the image information converter/transceiver 546, and the control information converter/transceiver 547 are connected to one or more antennas. For example, in FIG. 5B, the image information converter/transceiver is connected to an image information antenna 548 and the control information converter/transceiver is connected to a control information antenna 550. Such antennas are described with respect to FIG. 5A and, therefore, will not be discussed in detail with respect to FIG. 5B.

The embodiment shown in FIG. 5B also includes a remote device 552. As stated above, the remote device can be any type of device for communication of information to or from the image information antenna and/or the camera control antenna. Such devices include computing devices and non-computing devices such as remote RF transmitting devices, and the like.

FIG. 6A is an exemplary table of information illustrating the horizontal fields of view of various embodiments of the invention. The example apparatuses from which these calculations are based can include up to 6 different cameras and are based upon using NTSC standard video signals, however, embodiments of the present invention are not limited to such criteria.

The density of a frame of image data is measured in pixels, or oftentimes, mega-pixels (a mega-pixel=one million pixels). The table in FIG. 6A provides calculations for cameras having a number of mega-pixel densities. For example, column 654 includes densities of 0.3, 1.3, 2, 3, 4, 5, 9, and 12 mega-pixels. So to clarify this concept, a 3 mega-pixel camera provides 3 million pixels per image frame. A picture is typically one image frame. Video is a stream of image frames and is measured in frames per second (fps). Examples of video speeds include 15, 30, and 60 fps.

The vertical and horizontal dimensions of frames captured and/or transferred can vary from component to component. For instance, under the NTSC standard, the horizontal pixel dimension for the NTSC signal is 720 pixels and the vertical pixel dimension is 486 pixels. As demonstrated in the table of FIG. 6A, a camera can have a density higher or lower than the NTSC standard signal. And, for example, the horizontal and vertical pixel densities are shown at columns 656 and 658 respectively.

The ratio of the horizontal pixel density of the camera to the NTSC standard is calculated in column 660. For instance, for the 3 mega-pixel camera, the camera has 2048 horizontal pixels and the NTSC standard has 720 horizontal pixels. Accordingly, the ratio of the horizontal pixel densities is:
NTSC horizontal pixels/camera horizontal pixels=0.3515625 (1)
which is shown as 0.35 in column 660.

From such ratios, the fields of view, such as the horizontal fields of view shown in the table of FIG. 6A, for various cameras can be calculated. For example, in one embodiment discussed in FIG. 6A, the first camera (indicated as lens 1 at 662) has a 90 degree high horizontal field of view and a 3 mega-pixel density, the low horizontal field of view for this camera is 38.740 degrees. This calculation is based upon the following equation (in radians):
360*Arc Tan (ratio calculated above*Tan (high horizontal field of view*π/360))/π=38.740 (2)
The calculated low horizontal field of view value is the “zoomed” field of view of the camera.

In the embodiments described in the table of FIG. 6A, the next camera (lens 2 on the table at 662) has a high horizontal field of view that is the same as the low calculated horizontal field of view provided above (i.e., 38.740). In this example, the number 38.740 is substituted for 90 degrees in equation (2) and the computation is done again. The result is a low horizontal field of view of 14.092 degrees. The other quantities of the table are similarly calculated using the above equation.

Based upon the table of FIG. 6A, a number of cameras and type of cameras can be selected based upon the desired pixel density and field of view. For example, by using such calculations, an apparatus having six, three mega-pixel cameras can be designed, with each camera having a different field of view range based upon the data calculated in row 653. In such embodiments, there is no overlap between the fields of view of the multiple cameras. However, the embodiments of the invention are not so limited.

FIG. 6B is an exemplary table of information illustrating the zoom ratios of various embodiments of the invention. In the described embodiments, the table provides zoom factors that can be implemented with a series of six cameras (i.e., described as lenses 1-6 on the table at 664). The leftmost four columns of the table are the same as the table in FIG. 6A because the cameras being described in tables 6A and 6B have the same pixel densities. In order to calculate the zoom ratio for these cameras, the following equation can be used:
1/ratio calculated in equation (1)*Tan (high horizontal field of view *π/360) (3)
Accordingly, for a 3 mega-pixel camera having a 90 degree high horizontal field of view, the zoom ratio is 2.844.

In the embodiments described in the table of FIG. 6B, the next camera (lens 2 on the table) has a high horizontal field of view that is the same as the low calculated horizontal field of view for that lens provided by the table in FIG. 6A above (i.e., 14.092). In this example, the number 14.092 is substituted for 90 degrees in equation (3) and the computation is done again. The result is a zoom ratio of 23.014. The other quantities of the table are similarly calculated using the above equation.

Based upon the tables of FIGS. 6A and 6B, a number of cameras can be selected based upon the desired pixel density, field of view, and/or zoom ratio. For example, by using such calculations, an apparatus having six, three mega-pixel cameras can be designed, with each camera having a different zoom ratio range based upon the data calculated in row 655.

Further, as was the case with the fields of view calculations provided above, in such embodiments, there is no overlap between the zoom ratios of the multiple cameras that are calculated in the table of FIG. 6B. However, the embodiments of the invention are not so limited.

Although specific embodiments have been illustrated and described herein, those of ordinary skill in the art will appreciate that any arrangement calculated to achieve the same techniques can be substituted for the specific embodiments shown. This includes the use of cameras having different pixel densities within a multiple camera array, as well as variation in the lenses used, and orientations of the cameras with respect to each other in a multiple camera array. This disclosure is intended to cover adaptations or variations of various embodiments of the invention. It is to be understood that the above description has been made in an illustrative fashion, and not a restrictive one.

Combination of the above embodiments, and other embodiments not specifically described herein will be apparent to those of ordinary skill in the art upon reviewing the above description. The scope of the various embodiments of the invention includes various other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

What is claimed:

1. A digital surveillance camera, comprising:
a lens having a field of view;
wherein the lens is mounted to an imaging circuit board; and
an imaging circuit provided on the imaging circuit board for converting image data from the lens into a digital field of view.

2. The camera of claim 1, wherein the imaging circuit selects a portion of the image data for conversion based upon a selected area within a field of view.

3. The camera of claim 1, wherein the camera also includes a signal processing board for performing a conversion of the image data into a signal to be transmitted.

4. The camera of claim 1, wherein the camera has a digital zooming capability.

5. The camera of claim 1, wherein the camera has a digital panning capability.

6. The camera of claim 1, wherein the camera is mounted to movable mount structure.

7. The camera of claim 1, wherein the camera is mounted to fixed mount structure.

8. A camera array, comprising:
a first camera having a first field of view;
a second camera having a second field of view that different than the first field of view; and
wherein the first and second cameras are fixed with respect to each other.

9. The array of claim 8, wherein the second field of view is wider than the first field of view.

10. The array of claim 9, wherein the digital cameras have digital magnification capabilities.

11. The array of claim 9, wherein the digital cameras have digital demagnification capabilities.

12. The array of claim 9, wherein at least one of the first and second cameras has a digital panning capability.

13. The array of claim 8, wherein the first and second cameras are each directed to a same focal point.

14. The array of claim 8, wherein the array includes a third camera and a fourth camera and wherein the cameras have a progressively larger field of view from the first camera to the fourth camera.

15. The array of claim 14, wherein the progressively larger field of view from the first camera to the fourth camera is provided by the first camera having a high field of view of 90 degrees, the second camera having a high field of view of 30 degrees, the third camera having a high field of view of 10 degrees, and the fourth camera having a high field of view of 3.3 degrees.

16. An apparatus, comprising:
a camera array including:
a first camera having a first field of view;
a second camera having a second field of view that is wider than the first field of view; and
a movable mount for moving the camera array.

17. The apparatus of claim 16, wherein the first and second cameras are directed to a same focal point.

18. The apparatus of claim 16, wherein the movable mount can rotate 180 degrees around a center point in one dimension.

19. The apparatus of claim 18, wherein the movable mount can rotate 180 degrees around the center point in a second dimension.

20. An apparatus, comprising:
a camera array including;
a first camera having a first field of view;
a second camera having a second field of view that is wider than the first field of view; and
wherein the first and second cameras generate image data; and
an imaging circuit for converting the image data into a digital field of view.

21. The apparatus of claim 20, wherein the apparatus includes a switching circuit for switching between the image data from the first camera and the image data from the second camera for conversion into the signal to be transmitted.

22. The apparatus of claim 20, wherein the imaging circuit selects a portion of the image data for conversion based upon a selected field of view.

23. The apparatus of claim 22, wherein the imaging circuit selects a portion of the image data for conversion based upon a selected area within a field of view.

24. The apparatus of claim 20, wherein each camera includes an imaging circuit for converting the image data.

25. The apparatus of claim 20, wherein the apparatus also includes a digital signal processing board for performing the conversion of the data into a signal to be transmitted.

26. A multiple camera system, comprising:
a camera array including;
a first camera having a first field of view;
a second camera having a second field of view that is wider than the first field of view; and
wherein the first and second cameras generate image data; and
a computing device having computer executable instructions for receiving the image data.

27. The system of claim 26, wherein the computing device includes a display for displaying the received image data.

28. The system of claim 26, wherein the computing device includes a printer for printing the image data.

29. The system of claim 26, wherein the computing device includes computer executable instructions to send image data requests to the camera array.

30. The system of claim 29, wherein image data requests include a camera to be selected to obtain a view and a field of view.

31. The system of claim 29, wherein the computing device includes a user interface to allow a user to make image data requests.

32. An apparatus, comprising:
a camera array including:
a first camera having a first field of view;
a second camera having a second field of view that is wider than the first field of view; and
wherein the first and second cameras generate image data;
a movable mount for moving the camera array;
an image data transceiver; and
a mount controller.

33. The apparatus of claim 32, wherein the image data transceiver includes an NTSC antenna for transmitting image data to a remote device.

34. The apparatus of claim 32, wherein the mount controller includes an RF antenna for receiving control signals from a remote device.

35. The apparatus of claim 34, wherein the mount controller includes an antenna for receiving control signals from a remote computing device.

36. The apparatus of claim 32, wherein the apparatus includes an imaging component that includes mega-pixel imaging control and interfacing circuitry.

37. The apparatus of claim 36, wherein the apparatus includes a digital signal processor that controls the imaging component.

38. The apparatus of claim 32, wherein the mount controller includes circuitry to receive a signal from a remote device.

39. The apparatus of claim 38, wherein the mount controller includes circuitry to move the movable mount based upon the received signal.

40. The apparatus of claim 32, wherein the mount controller includes computer executable instructions to receive signals from a remote device and to move the movable mount based upon the received signal.

41. The apparatus of claim 32, wherein the image data transceiver includes computer executable instructions for receiving instructions from a remote device and for selecting a field of view based upon the received instructions.

42. The apparatus of claim 41, wherein the image data transceiver includes computer executable instructions for receiving instructions from a remote device and for selecting one of the cameras based upon the received instructions.

43. The apparatus of claim 32, wherein the mount controller includes computer executable instructions to receive signals from a remote device to digitally pan the field of view in a particular direction.

44. The apparatus of claim 43, wherein the mount controller includes computer executable instructions to move the movable mount on an edge of a digital field of view is reached.

45. The apparatus of claim 32, wherein the apparatus includes computer executable instructions for receiving instructions from a remote device and for selecting a field of view based upon the received instructions.

46. The apparatus of claim 45, wherein receiving instructions for selecting the field of view includes receiving instructions for selecting zoom and pan instructions.

47. The apparatus of claim 46, wherein receiving instructions for selecting the field of view includes receiving instructions regarding a digital field of view and instructions regarding movement of the movable mount.

48. The apparatus of claim 32, wherein the mount controller is associated with a guidance apparatus to direct movement of the cameras with respect to a location of a target.

49. A camera array, comprising:
a first camera having a first field of view;
a second camera having a second field of view that is different from the first field of view;
wherein the first and second cameras are fixed with respect to each other; and
an imaging circuit for combining image data from the first and second cameras into a composite image data set.

50. The array of claim 49, wherein the first and second cameras are digital cameras.

51. The array of claim 49, wherein the imaging circuitry includes circuitry to provide zoom and pan functionality to the camera array.

52. The array of claim 49, wherein the imaging circuitry includes computer executable instructions to define data for a portion of the composite image data set which represents a particular field of view within a composite field of view provided by the combined fields of view of the first and second cameras.

53. The array of claim 49, wherein the fields of view of the first and second cameras each have at least three edges and wherein the fields of view of the first and second cameras abut along at least a portion of one edge.

54. The array of claim 49, wherein at least a portion of the fields of view of the first and second cameras overlap.

55. The array of claim 49, wherein the first and second cameras are each directed to a different focal point.
